(19) United States
(12) Patent Application Publication
(10) Pub. No.: US 2010/0078908 A1
(43) Pub. Date: Apr. 1, 2010

(54) STROLLER HAVING A SEAT BELT ATTACHMENT AND ADJUSTMENT DEVICE

(76) Inventor: Martin Pos, Bayreuth (DE)

Correspondence Address: DRINKER BIDDLE & REATH LLP;ATTN: PATENT DOCKET DEPT., 191 N. WACKER DRIVE, SUITE 3700, CHICAGO, IL, 60606, US

(21) Appl. No.: 12/530,981

(22) PCT Filed: Mar. 14, 2008
(86) PCT No.: PCT/EP08/02062

§ 371 Date: Oct. 16, 2009

(30) Foreign Application Priority Data
Mar. 22, 2007 (DE) 10-2007-013-766.6

(51) Int. Cl. B62B 9/24; B60R 22/12; B62B 7/00; B60R 22/18

(52) U.S. Cl. 280/47.38; 297/468; 297/484

(57) ABSTRACT

The invention relates to a child transporter, especially a stroller, buggy or like carriage for children, having a seat surface and a back rest, a belt fastening and adjusting device being arranged in the front edge region of the seat surface.

The invention relates to a child transporter, especially a stroller, buggy or like carriages for children, in accordance with the preamble of patent claim 1.

Child transporters, especially strollers, buggies or like carriages for children, have been known for a long time and are used for the practical transport of babies and infants. Whereas babies in child transporters almost always lie relatively still and only, possibly, roll to the side, infants in child transporters, strollers or buggies are often highly active, for which reason there is a risk of those infants falling out of their carriage and injuring themselves in the process. For that reason it is necessary to use a protection system, for example in the form of a belt system, by means of which the occupants of such child transporters, strollers, buggies or similar carriages for children, namely babies and especially infants, are prevented from falling out. Hitherto there has customarily been used for that purpose a hip belt, which is placed around the infant in the region of the pelvis, the two ends of the hip belt being fastened to respective frame parts of the child transporter. As an alternative to such a hip belt there has also been used hitherto a chest harness, which was fastened, for example by means of a strap, to the child transporter, preferably to the framework thereof.

However, the two afore-mentioned safety systems have serious shortcomings, the use of a hip belt, especially in the case of a stroller or buggy, offering only inadequate protection against falling out, because a child can topple out from such a belt if it leans over to the side. A chest harness, in contrast, offers somewhat better protection but, because of the many loops and straps, its handling is complicated with the result that, because it is complicated to handle, use of the chest harness is often dispensed with altogether or the chest harness is not correctly put on or not correctly connected to the child transporter.

In the case of the two afore-mentioned safety systems there is furthermore the problem that not every child transporter, or stroller or buggy, is suitable for the fitting of such a safety system because, for example, some of the afore-mentioned transporters already have their own hoop mechanisms for protecting against falling out, although these too almost always offer only inadequate protection, in which case, however, such transporters then frequently offer no further possibility for fitting a safe protecting device preventing a child from falling out of such a child transporter.

The invention is based on the problem of making available a child transporter, especially a stroller, buggy or like carriage for children, which offers children, especially infants, improved protection against falling out, which avoids the afore-mentioned disadvantages and which, in addition, is simple and cheap to manufacture.

The problem is solved by a child transporter according to patent claim 1.

The problem is solved especially by a child transporter, especially a stroller, buggy or like carriage for children, having a surface and back rest, wherein a belt fastening and adjusting device is arranged in the front edge region of the seat surface.

The belt fastening device herein is provided as part of a belt system which includes two shoulder belts which are connectible to the belt fastening device in each case by means of a closing element. This connectibility of the closing elements to the belt fastening device is achieved preferably by means of a snap-in closure. The shoulder belts are preferably in the form of so-called trouser-braces belts, which extend upwards from a crotch region of a child sitting on the seat surface, preferably symmetrically, over its shoulders and which, on the other hand, again preferably symmetrically, extend over its thighs and are connected to lateral frame parts of the child transporter. For this purpose, the two belts are each passed through a belt lead-through located at the closing element in the hip region and turned back on themselves. Furthermore, in the shoulder region the two belts are passed through a belt guideway in the frame or framework of the child transporter and again turned back on themselves in a downwards direction. Alternatively to belt lead-throughs in the framework of the child transporter, belt guideways that are fastened to the framework can also be used. Furthermore, the closing element is provided so as to be movable, that is to say slidable, on the particular associated belt.

As part of the belt system according to the invention, there is furthermore provided a belt adjusting device, the two shoulder belts having, on a side, remote from the seat surface or back rest, of a framework of the child transporter which can be brought into a sitting position, an extension which extends through the belt adjusting device. In that case, the two shoulder belts are brought together, preferably on the side remote from the seat surface and back rest, into a belt having the afore-mentioned extension. Alternatively, the two belts themselves can also have a separate extension of such a kind, those two separate extensions then in each case individually extending through the belt adjusting device. It should however be mentioned that the first alternative, wherein the two shoulder belts merge into one extension, is preferred, because by that means it is always possible for the shoulder belts to be tightened evenly by means of the belt adjusting device.

The belt fastening and adjusting device is preferably arranged in a central region of the front edge region of the seat surface because, by that means, the sitting child can be secured in the stroller or buggy symmetrically in optimum manner. The seat surface and/or back rest of the particular carriage are in this case preferably made from a flexible, especially textile, material or at least include such a material, so that it is possible for the stroller or buggy to be folded up in simple manner. The flexible seat surface and/or back rest is in this case stretched out between appropriate frame parts of the framework of the child transporter.

The afore-mentioned extension of the shoulder belts extends in the back region of the child transporter at least in part in and/or on a guideway which is arranged on that side of the framework which is remote from the seat surface and/or the back rest. The provision of such a guideway advantageously ensures that, when the belts are tightened, the extension extends along the seat surface and back rest of the child transporter without deformation of the seat surface and back rest occurring as a result of the tightened extension belt. In addition, the use of a guideway prevents the extension belt from becoming tangled or from sagging.

In accordance with an embodiment, the belt fastening device is arranged above the seat surface and is fixed thereon so as to be tiltable, the belt fastening device in a position of non-use lying substantially on top of the seat surface, optionally as a result of the action of a spring. By this means it is ensured, on the one hand, that the belt fastening device is very readily accessible, so that the particular closing elements can be simply inserted in the belt fastening device and latched therein. Optionally, the two closing elements, before being introduced into the belt fastening device, are brought into form-fitting connection with one another so that unitary, combined problem-free introduction into the belt fastening device, which is preferably in the form of a snap-in closure, is possible.

In accordance with a further embodiment, the belt fastening device can be recessed in the seat surface so that, from above the seat surface, only the introduction slot for closure and snap-in projections provided on the closing element is visible, which projections are necessary in known manner for a snap-in closure.

The extension of the shoulder belts is loadable from one side, and releasably locked, in the belt adjusting device by means of a clamping device, especially a cam-type device, so that the extension can be pulled in one direction through the belt adjusting device, whereupon the shoulder belts become taut and ensure that the child is held securely on the seat surface of the child transporter. The clamping device ensures in the process that it is possible for the belt extension to slip back only when the clamping device is released, there being provided in accordance with the invention a releasing device, for example in the form of a simple lever or pushing mechanism. The clamping device is so constructed that slipping back of the belt is reliably prevented. In other words, loadability of the clamping device in the direction of the shoulder belts is accordingly possible whilst tightening of the shoulder belts by pulling on the extension belt extending through the belt adjusting device is possible.

In accordance with an embodiment of the invention, the belt adjusting device is arranged substantially beneath and/or in the same plane as the surface, a releasing device for releasing the clamping device being accessible from above the seat surface. In accordance with this embodiment, the extension of the shoulder belts extends beneath the seat surface into the belt adjusting device, extends through the latter, especially through the clamping device located in the belt adjusting device, and emerges at a belt lead-through located in the front region of the seat surface or belt adjusting device. This belt extension extending out from the belt adjusting device can be pulled so that the shoulder belts and also the belt portions extending over the thighs of the child are tightened, thereby securing the child.

In accordance with a further embodiment, the belt fastening device is constructed as a unit with the belt adjusting device, the belt fastening device and the belt adjusting device being tiltable optionally relative to one another and/or in relation to the seat surface on one or more axes. The belt fastening device is in this case secured to the belt adjusting device by means of a rivet or bolt connection, although such a connection can also be made by means of a belt. Connection of the belt adjusting device to the seat surface can accordingly likewise be accomplished by means of a rivet or bolt connection or, however, by means of a belt.

The tiltability of the belt fastening device relative to the belt adjusting device and/or relative to the seat surface ensures optimum adaptation of this unit to a child sitting on the seat surface, the unit of the belt fastening device and belt adjusting device making possible optimum adaptation to the space defined by the sitting child for this unit between the legs of the child. In this context it should be emphasised that tiliting preferably along the longitudinal axis of the child transporter is possible; however, in the case where a belt is used between the seat surface, the belt adjusting device and the belt fastening device, tilting in a transverse direction to that longitudinal axis is of course also possible. Of course, a ball-and-socket joint could also be used here.

In accordance with the invention, the unit or the belt fastening device and/or the belt adjusting device is arranged at least in part within a casing, especially a sheath. This sheath, or casing, comprises a soft and/or yielding material, especially rubber, so that, on the one hand, a pleasant feel and, on the other hand, protection against injuries are ensured by this casing.

The afore-mentioned unit or the belt fastening device and/or the belt adjusting device is fastened, by means of a fastening device, especially a base plate, on the seat surface, especially substantially beneath the seat surface, using holding parts extending through the seat surface. To these holding parts, which start at the base plate and extend through the seat surface, there is fastened either the unit of the belt fastening device and belt adjusting device or, however, the belt fastening device and/or the belt adjusting device as previously mentioned, for example by means of rivets or bolts or with the aid of a belt.

Furthermore, the seat surface and/or the back rest is at least in part supported, especially by means of at least one, preferably flat, support member. This support member advantageously consists of plastics material and ensures an optimum fitting shape of the seat surface and back rest even in the loaded state, with deformation due to loading, for example caused by stretching of the seat surface and back rest, being avoided. Furthermore, this support member can also be used as a guideway for the afore-mentioned extension of the shoulder belts. For that purpose, individual guide elements can be provided on the support member.

In addition, at least part of the support member can form the fastening device for attaching the belt fastening device and/or the belt adjusting device or the unit thereof. In accordance with a further variant, the support member can also co-operate with the fastening device and, for example, have a stabilising effect thereon.

Further embodiments of the invention arise from the subordinate claims.

The invention is described hereinbelow with reference to examples of embodiments, which are explained in further detail with reference to the Figures, in which:

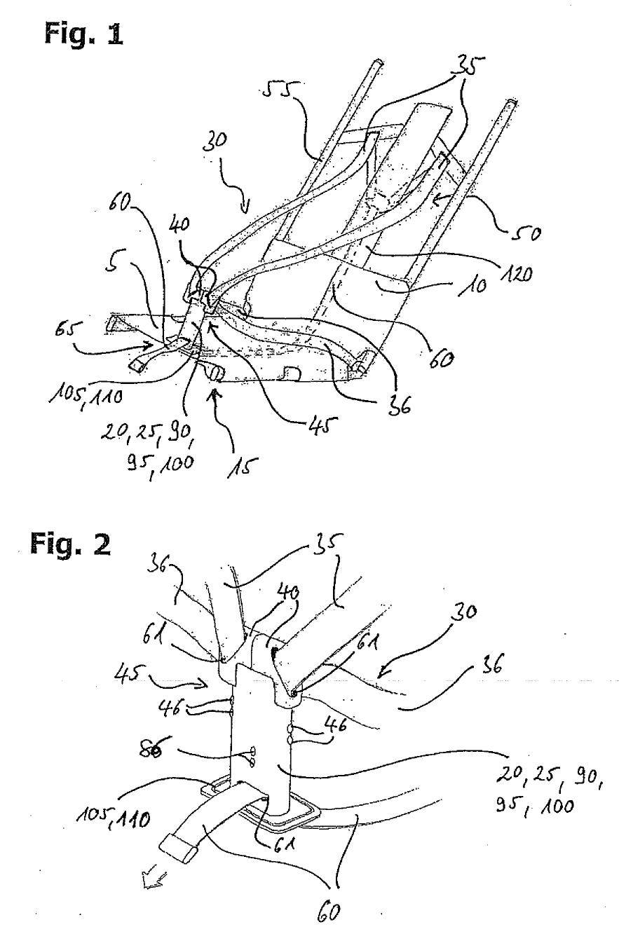

FIG. 1 shows, in diagrammatic form, a first embodiment of the invention, with only the basic frame parts, the seat surface, the back rest and the associated belt system being shown;

FIG. 2 is a view of a detail of the belt system according to FIG. 1;

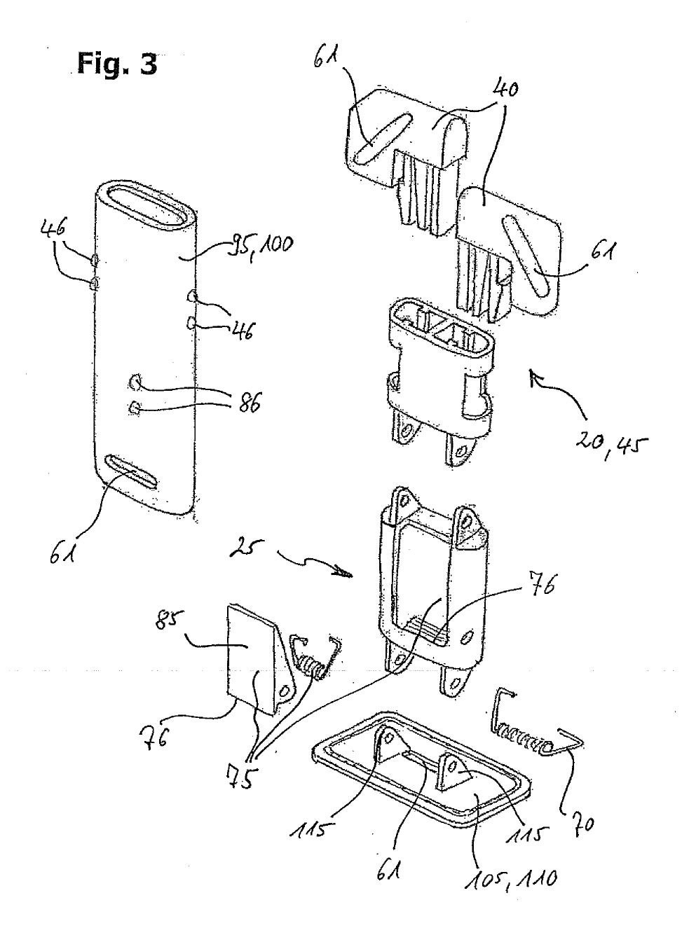

FIG. 3 is an exploded view of the functional components of the belt fastening device and belt adjusting device according to the invention;

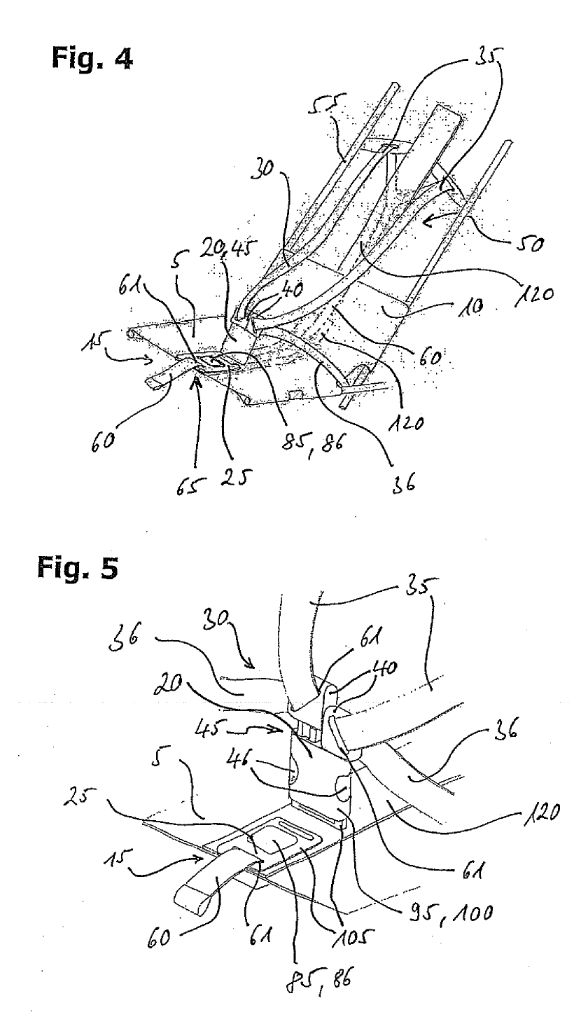

FIG. 4 shows, in diagrammatic form, a further embodiment of the invention by means of its basic components;

FIG. 5 is an enlargement of part of the belt system according to FIG. 4; and

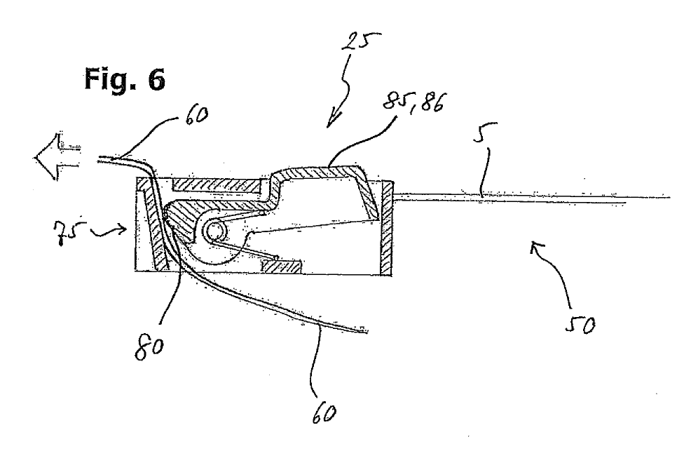

FIG. 6 is a view, in diagrammatic form, of a detail of the belt adjusting device according to FIGS. 4 and 5.

The same reference numerals are used in the description hereinbelow for parts that are the same and parts that have the same effect.

FIG. 1 shows the framework 55 of a stroller or buggy according to the invention, having a seat surface 5, a back rest 10 and, arranged in the rear region of the back rest, a support member 120, which is in the form of a flat support for the back rest 10. The support member 120 is made of plastics material, but could also, alternatively, consist of a strong textile fabric, which is fixed in the region of the back rest 10 to the latter and, in addition, in the upper region of the framework 55 of the child transporter.

FIG. 1 furthermore shows a belt system 30 consisting of two shoulder belts 35, two closing elements 40 slidably arranged on the shoulder belts, an extension 60 that continues on from the shoulder belts 35, a belt fastening device 20 and a belt adjusting device 25. The shoulder belts 35 are each sub-divided, by the closing elements 40, into a thigh belt portion 36 and a shoulder belt portion 35, the belt at its thigh belt portion 36 end being fastened to the framework 55 of the child transporter in a rear region of the seat surface 5. From that fastening point, the belt extends through a belt lead-through 61 of the closing element 40 into the belt portion associated with a child's shoulder, which portion in the context of this invention is referred to as a shoulder belt 35. This shoulder belt 35 in turn extends through a belt lead-through 61 of the framework 55 of the child transporter into a rear region 50 (namely a region remote from the seat surface 5 and the back rest 10), where the two shoulder belts 35 pass into a common extension 60 of the shoulder belts 35. This extension 60 is fixedly connected to the shoulder belts 35 and extends away from the connection location in the direction of the underside of the seat surface 5, where this extension 60, as is clearly shown in FIG. 3, extends through a belt lead-through 61 provided in the base plate 110 serving as a fastening device 105. In its further course, the extension 60 extends through a clamping device 75 and also through a further belt lead-through 61 provided in a casing 95 or sheath 100. The latter is clearly shown in FIGS. 1 and 2.

By means of a pull on the extension 60 extending out from the belt lead-through 61 located in the sheath 100, in the direction of the arrow according to FIG. 2, the belt system can be tightened in the thigh belt portion 36 and also in the region of the shoulder belt 35, with the clamping device, which is clearly shown in FIG. 3, preventing the extension 60 from slipping back. The clamping is brought about, on the one hand, by means of a spring located in the clamping device 75 and, on the other hand, by means of its dimensions, which are so proportioned that the extension belt 60 is held on associated clamping edges 76 of the clamping device 75 and accordingly locked.

It is furthermore clearly shown in FIG. 1 that the belt fastening 20 and adjusting 25 device is arranged at the front edge region 15 of the seat surface 5, more specifically in a central front region 65 of the seat surface 5.

It is furthermore clearly shown in FIG. 1 and FIG. 2 that the belt fastening 20 and adjusting 25 device are constructed as a unit 90, which is surrounded by a casing 95, namely a sheath 100, which has both an opening device 46 for the snap-in closure 45 of the belt fastening device 20 and also an actuating device 86 for the releasing device 85 of the belt adjusting device 25. Both the opening device 46 for the snap-in closure 45 and also the actuating device 86 for the releasing device 85 are, as is clearly shown in FIGS. 2 and 3, in the form of knob-like actuating buttons or pins, by means of which it is possible to exert pressure on the snap-in and locking mechanisms located beneath them, so that each of those mechanisms can be released.

In this context, FIGS. 1 and 2 show the belt fastening device 20 according to the invention together with the associated closing elements 40 in a closed position, whereas in FIG. 3 the belt fastening device 20 in the form of a snap-in closure 45 together with the associated closing elements 40 is shown in an open position. The unit 90 of the belt fastening device 20 and belt adjusting device 25 is mounted on a base plate 110 serving as fastening device 105, which in accordance with FIG. 1 is located beneath the seat surface 5 and is fastened there. In this arrangement, holding parts 115 located on the base plate 110 extend through the seat surface 5 and serve as fastening points for the belt adjusting device 25, which has appropriate corresponding holding parts. Fastening of the belt adjusting device 25 to the holding parts 115 of the base plate 110 can alternatively be achieved by means of rivets or bolts or also, however, by means of screw connections. Correspondingly, a connection between the belt adjusting device 25 and the belt fastening device 20 is likewise possible by means of rivet, screw or bolt connection. As is furthermore clearly shown in FIG. 1, the base plate 110 has a belt lead-through 61, through which, as previously mentioned, the extension 60 extends in the direction of the clamping device 75 provided in the belt adjusting device 25.

As also already mentioned, the belt fastening device 20 and the belt adjusting device 25 is constructed as a unit 90, which is surrounded by a sheath 100, which in addition to an opening device 46 and an actuating device 86 has a further belt lead-through 61, which in the assembled state is located at approximately the same height as the clamping edges 76 associated with the clamping device 75, so that the belt extension 60 or extension 60 can be passed out from the sheath 100 without additional friction.

In use, that is to say when the closing elements 40 are latched into the belt fastening device 20, the unit 90 of the belt fastening device 20 and belt adjusting device 25 extends upwards, away from the seat surface 5. However, in a position of non-use, that is to say when the belt fastening device 20 and the closing elements 40 are not in engagement with one another, the unit 90 lies substantially on top of the seat surface 5. This is brought about on the one hand by the effect of gravity but also, in addition, by the action of the spring 70, which biases the unit 90 in the direction of the seat surface 5.

FIG. 4 shows a further embodiment of the invention, wherein the belt fastening device 20 and the belt adjusting device 25 are not constructed as a unit 90 but rather as separate components. In this case the belt routing corresponds substantially to that of FIGS. 1 and 2. However, in accordance with FIG. 4 and FIG. 5 the belt fastening device 20 is not directly connected to the belt adjusting device 25 but rather is fastened to the seat surface 5 of the child transporter.

The belt adjusting device 25 is located substantially beneath the seat surface 5 or passes through the seat surface 5, as is clearly shown in FIG. 6, in which case a functional part of the belt adjusting device 25 with the clamping device 75 is arranged beneath the plane of the seat surface 5 and only the extension 60 extending out from the belt adjusting device 25 and also the actuating device 86 and releasing device 85 for releasing the clamping device 75 are accessible from above the seat surface 5. In especially simple manner, the belt extension 60 extends in this case from below into the clamping device 75 of the belt adjusting device 25, which is in the form of a cam-type device 80 and clamps the belt in such a way that it can be pulled only in the direction of the arrow according to FIG. 6 whilst being firmly locked in the opposite direction, that is to say in the direction of the shoulder belts. By pressing on the releasing device 85 or actuating device 86, this clamping action can be temporarily overcome, said pressing being accomplished against the action of a spring, for example a leaf spring or a helical spring.

It is furthermore clearly shown in FIG. 4 that both the back region and also the remote side 50 of the back rest 10 and of the seat surface 5 are supported by a flat support member, which in the front edge region 15 of the seat surface 5 co-operates with the fastening device 105 by means of which both the belt fastening device 20 and also the belt adjusting device 25 are connected to the seat surface 5 and fastened thereto.

FIG. 5 furthermore shows, surrounding the belt fastening device 20, a casing 95, which contains two openings for actuation of the opening device 46 of the snap-in closure 45 of the belt fastening device 20. Fastening of the belt fastening device 20 to the seat surface 5 is achieved by means of a belt, so that the belt fastening device 20 can tilt over onto the seat surface 5 and, especially in a position of non-use, can lie on the top thereof.

At this point it should be pointed out that all the above-described parts, considered individually and in any combination, especially the details shown in the drawings, are claimed as being important to the invention. The person skilled in the art will be familiar with modifications thereto.

### LIST OF REFERENCE NUMERALS:

5 seat surface

10 back rest

15 front edge region of seat surface

20 belt fastening device

25 belt adjusting device

30 belt system

35 shoulder belt

36 thigh belt portion

40 closing element

45 snap-in closure

46 opening device for snap-in closure

47 snap-in closure

50 remote region

55 framework

60 extension

61 belt lead-through

65 central region 70 spring

75 clamping device

76 clamping edge

80 cam-type device

85 releasing device

86 actuating device for releasing device

90 unit

95 casing

100 sheath

105 fastening device

110 base plate

115 holding ties

120 support member

1. In a child transporter such as a stroller, buggy or like carriage for children having a seat surface and a back rest the improvement comprising a belt fastening and adjusting device arranged in the front edge region of the seat surface.

2. Child transporter according to claim 1, in which the belt fastening device is part of a belt system which includes two shoulder belts which are connectible to the belt fastening device in each case by means of a closing element, especially by means of a snap-in closure.

3. Child transporter according to claim 2, in which the belt adjusting device is part of the belt system, the two shoulder belts having, on a side, remote from the seat surface or back rest, of a framework of the child transporter which can be brought into a sitting position, an extension which extends through the belt adjusting device.

4. Child transporter according to claim 1, in which the seat surface and/or the back rest includes a flexible material.

5. Child transporter according to claim 1, in which the belt fastening and adjusting device are arranged in a central region of the front edge region of the seat surface.

6. Child transporter according to claim 3, in which the extension extends at least in part in and/or on a guideway which is arranged on that side of the framework which is remote from the seat surface and/or the back rest.

7. Child transporter according to claim 1, in which the belt fastening device is arranged above the seat surface and is fixed thereon so as to be tiltable, the belt fastening device lying on top of the seat surface in a position of non-use, optionally as a result of the action of a spring.

8. Child transporter according to, in which the extension is loadable from one side, and releasably lockable, in the belt adjusting device by means of a clamping device, especially a cam-type device.

9. Child transporter according to claim 8, in which the belt adjusting device is arranged substantially beneath and/or in the same plane as the seat surface, a releasing device for releasing the clamping device being accessible from above the seat surface.

10. Child transporter according to claim 1, in which the belt fastening device forms a unit with the belt adjusting device, the belt fastening device and the belt adjusting device being tiltable optionally relative to one another and/or in relation to the seat surface on one or more axes.

11. Child transporter according to claim 10, in which the unit or the belt fastening device and/or the belt adjusting device is arranged at least in part within a casing.

12. Child transporter according to claim 10, in which the unit or the belt fastening device and/or the belt adjusting device is fastened, by means of a fastening device (105), especially a base plate, on the seat surface, especially substantially beneath the seat surface, using holding parts extending through the seat surface.

13. Child transporter according to claim 1, in which the seat surface and/or the back rest is at least in part supported, especially by means of at least one, preferably flat, support member.

14. Child transporter according to claim 12, in which part of the support member forms the fastening device and/or it co-operates with the fastening device.

15. Child transporter according to claim 11, in which the casing comprises a soft and/or yielding material.
